(19) United States
(12) Patent Application Publication
(10) Pub. No.: US 2010/0327091 A1
(43) Pub. Date: Dec. 30, 2010

(54) SAFETY SYSTEMS AND METHODS FOR CONTROLLING OPERATION OF OFFICE EQUIPMENT

(75) Inventor: JOSEPH Y. KO, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(73) Assignee: TECHKO, INC., Laguna Hills, CA (US)

(21) Appl. No.: 12/491,137

(22) Filed: Jun. 24, 2009

(51) Int. Cl. B02C 23/04

(52) U.S. Cl. 241/25; 241/36; 241/34

(57) ABSTRACT

Safety systems and methods are disclosed for controlling operation of office equipment, such as a paper shredder. In one example, the method includes enabling operation of an electric motor configured to drive at least one moveable component of an electronic office appliance. Upon detection of human motion within a prescribed safety zone defined by at least one passive infrared (PIR)-based motion detector during operation of the electric motor, the electric motor is disabled. In one example, the electronic office appliance includes at least two PIR-based motion detectors positioned near at least one moveable component of the electronic office appliance. Operation of the electric motor can be resumed after a predetermined time interval has elapsed without the detection of subsequent human motion within the prescribed safety zone.

### BACKGROUND

1. Field

Embodiments of the invention generally relate to safety systems and methods for controlling operation of office equipment.

2. Description of the Related Art

As technology improves, various types of office equipment are becoming more accessible to a greater number of users. For instance, home-offices are becoming more popular as individuals transition to working out of their residences.

Many types of office equipment, however, can present a hazard to young children or other individuals if actuated inadvertently. For example, consumer paper shredders generally contain a series of cutting elements for shredding articles fed therein and can present a dangerous environment to small children who may insert their hands or other objects into a throat of a shredder. In addition, children's fingers can be pulled into the paper shredding mechanism if they do not let go of the paper. Such injuries can occur even when an adult is supervising a child.

In an effort to reduce injuries associated with automatic-feed shredders, certain shredder designs include an extended throat as part of a paper feed tray. Such a throat design can prevent an individual's hand or other non-paper objects from directly accessing the cutting elements and/or from being inadvertently pulled into the shredder device via the automatic-feed mechanism. However, as sheet capacities of the paper feed trays increase, so must the length of the extended throat in order to provide adequate protection.

### SUMMARY

In view of the foregoing, a need exists for office equipment having an improved safety feature for controlling operation of the office equipment. Moreover, there is a need for safety systems and methods that do not require adult supervision to be implemented. Further, there is a need for safety systems and methods that do not require actual physical contact with the office equipment to disable operation.

For example, certain embodiments of the invention include proximity sensors that can detect human or animal motion near a potentially dangerous access region of a piece of office equipment. Inventive systems and methods can then advantageously disable operation of the piece of office equipment when human motion is detected in close proximity to the potentially dangerous access region.

In certain embodiments, a method is disclosed for controlling operation of electronic office equipment. The method includes enabling operation of an electric motor of an electronic office appliance, the electric motor being configured to drive at least one moveable component associated with the electronic office appliance. The method also includes detecting human motion within a prescribed safety zone in proximity with the at least one moveable component of the electronic office appliance by at least two passive infrared (PIR)-based motion detectors disposed on the electronic office appliance. The method further includes automatically disabling operation of the electric motor upon detecting human motion within the prescribed safety zone during operation of the electric motor. The method further includes resuming operation of the electric motor after a predetermined time interval has elapsed without the detection of subsequent human motion within the prescribed safety zone.

In other embodiments, a safety system is disclosed for controlling operation of electronic office equipment. The safety system includes an automatic office apparatus and multiple PIR-based motion detectors. The automatic office apparatus includes a controller, at least one moveable component, and an access region adjacent the at least one moveable component. The PIR-based motion detectors are positioned on substantially opposite ends of the access region, with the respective detection zones being defined by configurable detection angles of the PIR-based motion detectors. Upon detection of motion within a respective detection zone by at least one of the multiple PIR-based motion detectors, the at least one PIR-based motion detector is configured to transmit a motor stop signal to the controller of the automatic office apparatus to disable operation of the motor.

In certain embodiments, a safety-controlled automatic-feed shredding device is disclosed. The shredding device includes at least one cutting element configured to shred media coming in contact therewith during operation of the at least one cutting element. The shredding device also includes a feed tray having a feed mechanism configured to automatically advance the media to the at least one cutting element. The shredding device further includes at least one motor configured to drive the at least one cutting element and the feed mechanism. The shredding device also includes a housing substantially enclosing the at least one cutting element and the at least one motor, the housing including at least one access slot through which the media passes to come in contact with the at least one cutting element. The shredding device further includes multiple PIR-based motion sensors disposed on the housing. Each of the plurality of PIR-based motion sensors include a pyroelectric sensor element, wherein at least one of the plurality of PIR-based motion sensors is configured to generate a first signal when sensing motion of an individual within a detection zone at least above the housing, the detection zone encompassing a region including or substantially proximate the at least one access slot. The shredding device also includes a controller in communication with the PIR-based motion sensors and the at least one motor, the controller being configured to cause the at least one motor to cease driving the at least one cutting element in response to receiving the first signal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1A illustrates a front perspective view of a shredding device having a safety system, according to certain embodiments of the invention.

FIG. 1B illustrates a top view of the shredding device of FIG. 1A.

FIG. 2 illustrates a block diagram of a safety system, according to certain embodiments of the invention.

FIG. 3A illustrates an exemplary embodiment of detection zones associated with the shredding device of FIG. 1A.

FIG. 3B illustrates an exemplary embodiment of a detection zone associated with the shredding device of FIG. 1A.

FIG. 4 illustrates a flowchart of an exemplary embodiment of a safety process executable by the safety system of FIG. 2.

FIG. 5 illustrates a flowchart of an exemplary embodiment of another safety process executable by the safety system of FIG. 2.

FIG. 6 illustrates a cross-sectional view of another shredding device having a safety system, according to certain embodiments of the invention.

### DETAILED DESCRIPTION OF THE PREFERRED EMBODIMENTS

Embodiments of the invention include systems and methods for controlling operation of office equipment. In particular, certain embodiments include sensors for determining proximity or motion of a human, animal, or other living object near a potentially dangerous access region of a piece of office equipment, such as the throat of a paper shredder. In certain embodiments, such systems and methods cause a piece of office equipment to automatically cease operation upon detection of human movement within a predetermined safety zone in close proximity to a potentially dangerous access region.

The features of the systems and methods will now be described with reference to the drawings summarized above. Throughout the drawings, reference numbers are re-used to indicate correspondence between referenced elements. The drawings, associated descriptions, and specific implementation are provided to illustrate embodiments of the invention and not to limit the scope of the disclosure.

In addition, methods and functions described herein are not limited to any particular sequence, and the acts relating thereto can be performed in other sequences that are appropriate.

The term “media” as used herein is a broad term and is used in its ordinary sense and is used, without limitation, to describe generally planar household and office materials capable of being shredded. Such materials include but are not limited to, paper, paper with fasteners, compact disks, floppy disks, envelopes, credit cards, cardstock, memory cards and the like.

The term “consumer-sized” as used herein is a broad term and is used in its ordinary sense and is used, without limitation, to describe apparatus, devices, systems, and the like, that are generally used in a home or office setting. For example, a “consumer-sized shredder” refers to a shredder that is generally used in a home or a small office. For instance, a consumer-sized shredder may generally have a smaller shredding capacity than a larger, commercial-sized or industrial-sized shredder.

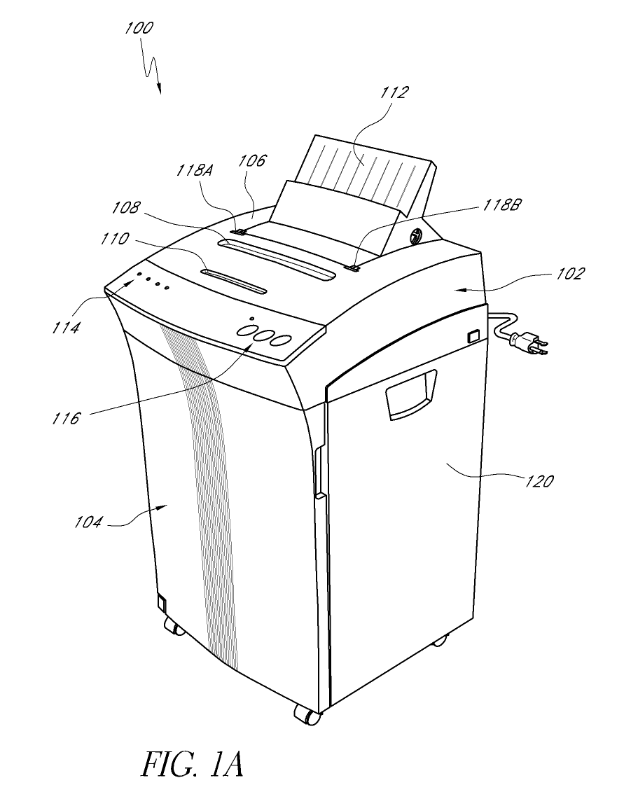

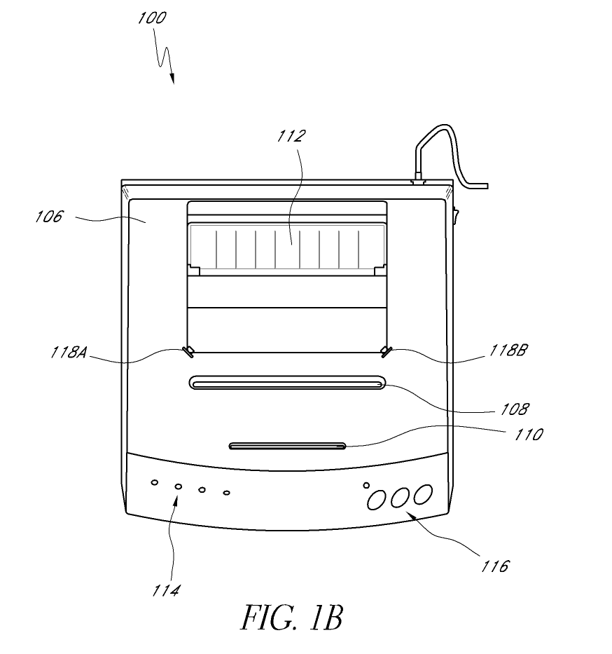

FIGS. 1A and 1B illustrate a front perspective view and a top view, respectively, of a shredding device 100 having a safety system, according to certain embodiments of the invention. As shown, the shredding device 100 includes a shredder portion 102 and a waste portion 104. In certain embodiments, the shredder portion 102 is configured to mount on a top side of the waste portion 104 during operation such that shredded material from the shredder portion 102 is caught by the waste portion 104. In certain embodiments, the shredder portion 102 and the waste portion 104 are separable. In other embodiments, the shredder portion 102 and the waste portion 104 are formed of a single integrated structure.

In other embodiments, the shredder portion 102 can be configured to mount on one or more other types of containers, such as circular and/or rectangular waste receptacles. In yet other embodiments, the shredder portion can sit above, without directly contacting, the waste portion 104. In general, the shredding device 100 can have any suitable construction or configuration and the illustrated embodiment of FIGS. 1A and 1B is not intended to be limiting in any way.

The illustrated shredder portion 102 further comprises a housing 106 with multiple openings for receiving material to be shredded. In particular, the housing 106 includes a paper feed slot 108 for receiving paper manually fed therein by a user. The housing 106 also includes a media feed slot 110 for receiving media to be shredded. For instance, the media feed slot 110 can be advantageously configured to receive one or more of the following: compact disks (CDs), floppy disks, credit cards, memory cards, or the like.

Positioned below the slots 108 and 110 are, respectively, paper blades and media blades (not shown). The paper blades are preferably configured to shred paper material into a plurality of pieces. For instance, the paper blades can comprise knife rollers with annular knife edges spaced substantially along the lengths of the rollers. This results in the paper being cut into strips having widths corresponding to the spacing of the annular edges. In other embodiments, knife rollers can be used that have sharpened edges formed thereon in a criss-cross fashion, which results in cross-cutting of the paper into substantially smaller pieces, similar to confetti.

In certain embodiments, the paper blades and the media blades are preferably made of steel or other appropriate material to provide adequate cutting of a plurality of sheets of paper and other types of media. Moreover, the paper blades can be configured to cut through an occasional staple or other fastener left in the stack of paper, which may comprise one or more stapled, multi-page documents. Although not shown, the paper blades and the media blades can be driven by one or more motors and/or gears.

The housing 106 further includes an auto feed feature for automatically feeding multiple pieces of paper to be shredded. In certain embodiments, the multiple pieces of paper are fed one by one in consecutive fashion. In other embodiments, the multiple pieces of paper are fed concurrently and/or in an overlapping fashion. As illustrated, a feed tray 112 is positioned at the rear of the shredder portion 102 and angled to direct paper material into the paper blades. It should be appreciated that the paper blades and the media blades of the shredding device 100 can present a dangerous environment to small children who may insert their hands or other objects into the slots 108, 110 or into the feed tray 112.

The housing 106 further includes a display portion 114 and an input control portion 116. In certain embodiments, the display portion 114 includes one or more light emitting diodes (LEDs) to indicate operational status and/or conditions. The input control portion 116 can comprise buttons, switches and the like to enable a user to input commands to control operation of the shredding device 100. Various embodiments of the display portion 114 and the input control portion 116 will be discussed in further detail herein.

The housing 106 can also advantageously include one or more safety sensors to prevent children or adults from injuring themselves by placing their hands or other items near the blades of the shredding device 100 or auto feed mechanism during operation. As shown, the housing 106 includes a pair of proximity sensors 118A, 118B positioned on opposite sides of the lower end of the feed tray 112. In other embodiments, the proximity sensors 118A, 118B can be positioned at other locations on the housing 106. In yet other embodiments proximity sensors can be placed near an access door 120 of the waste portion 104.

In certain embodiments, the proximity sensors 118A, 118B advantageously provide a safety system for the shredding device 100. For instance, upon detection of a nearby individual and/or other object, either or both of the proximity sensors 118A, 118B can transmit a detection signal usable to temporarily shut down operation of the shredding device 100.

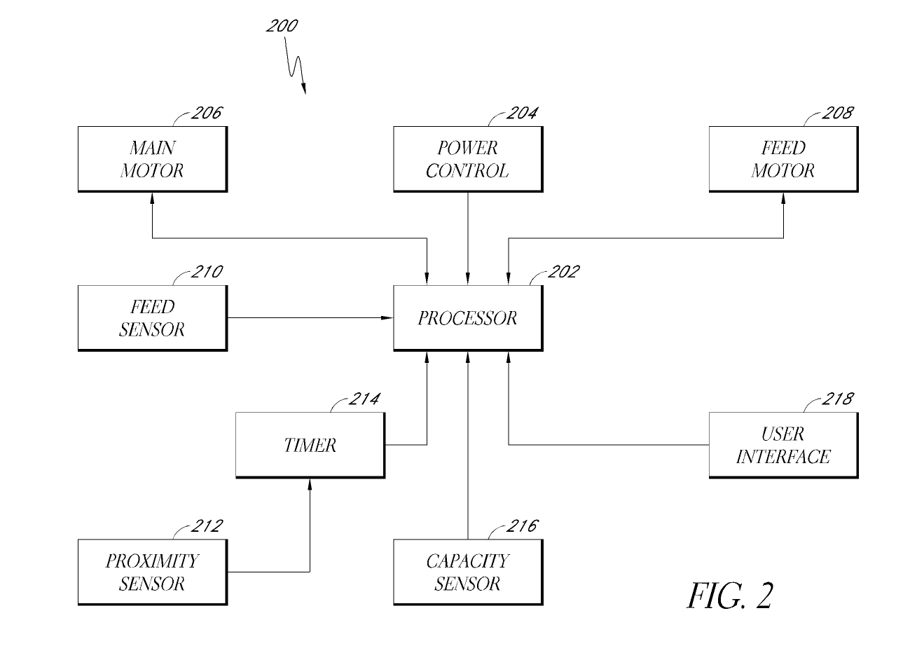

For example, FIG. 2 illustrates a block diagram of a safety system 200 in accordance with embodiments of the invention. Although the safety system 200 is described with reference to the shredding device 100 of FIGS. 1A and 1B in certain instances, the safety system 200 can be implemented on any piece of automatic office equipment, such as a shredder, laminator, letter folding machine, copier, printer, and/or other electrically-operated machine and therefore, the examples identified herein are not intended to be limiting.

The illustrated safety system 200 includes a processor 202, a power control 204, a main motor 206, a feed motor 208, a feed sensor 210, a proximity sensor 212, a timer 214, a capacity sensor 216, and a user interface 218. In certain embodiments, one or more of these components can be omitted.

In general, the processor 202 receives user input from the user interface 218 and receives sensor input from the sensors 210, 212, 216. The processor 202 controls operation of the main motor 206 and the feed motor 208 and can transmit output information (e.g., status, alarms, operational conditions) to the user interface 218. In certain embodiments, the processor 202 comprises a general or a special purpose microprocessor. In certain embodiments, the processor 202 can comprise a central processing unit (CPU), a master control unit (MCU), or other suitable controller. In yet other embodiments, the processor 202 can comprise an application-specific integrated circuit (ASIC) or one or more circuit modules configured to execute on one or more processors. For example, the processor 202 can include a first control circuit for the proximity sensor 212 and a second control circuit for the capacity sensor 216.

The power control 204, in general, supplies and controls the supply of power to certain components of the piece of office equipment. Power can be received externally (e.g., via a standard electrical outlet or wall socket) or internally (e.g., via a battery or capacitive storage device). The power received by the power control 204 can be in the form of an alternating current (AC) and/or direct current (DC). In order to comply with the particular power requirements of the various system components, the power control 204 can advantageously include one or more power adaptors or converters to convert from AC power to DC power or vice-versa and/or to step up or step down the input power or voltage level. In certain embodiments, the power control 204 supplies AC power to the main motor 206 and to the feed motor 208. The power control 204 can supply DC power to the processor 202 and other circuit components that require a DC power input.

In certain embodiments, the main motor 206 controls operation of one or more moveable components of the office equipment. The main motor 206 can be used in conjunction with drive gears, drive belts or straps, actuators, and the like to effect motion. With reference to the shredding device 100, the main motor 206 can effect rotation of the paper blades, the media blades and/or the paper feed mechanism. In other embodiments, the main motor 206 can effect rotation of rollers or lateral movement of print heads or other moving components. In certain embodiments, the main motor 206 comprises one or more safety devices to prevent the main motor 206 from overloading or overheating. For example, the main motor 206 can include a temperature breaker and/or a Hall magnetic sensor. The safety devices can transmit signals to the processor 202 that contain information regarding operational conditions of the main motor 206.

Operation of the main motor 206 can be controlled by the processor 202. For example, the processor 202 can generate control signals to cause the main motor 206 to start, stop, resume, and/or operate in reverse. In certain embodiments, a relay control circuit (not shown) can be used to control the interface between the processor 202 and the main motor 206. The relay control circuit can be built in, or integrated, with the main motor 206. In certain embodiments, the relay control circuit can include overheat prevention circuitry to automatically stop the main motor 206 when the temperature of the main motor 206 reaches a predetermined threshold temperature, thereby preventing overheating.

In certain embodiments, the relay control circuit can further include overload prevention circuitry to automatically stop the main motor 206 when a threshold torque level is exceeded. The torque level can be exceeded, for example, if too much paper is inserted into an entry point of a piece of office equipment (e.g., into a throat of a shredder). In certain embodiments, the overload prevention circuitry can cause the main motor 206 to automatically reverse direction in order to back out the inserted paper.

The feed motor 208 can control the feeding of paper documents or other media into the office equipment. In certain embodiments, the feed motor 208 can be a component of an auto-feed feature that enables multiple documents to be fed through a piece of equipment either consecutively or at the same time without requiring user interaction. In certain embodiments, the feed motor 208 is an isochronous motor that controls operation of an internal component that “catches” the paper in a feed tray and advances it into the piece of office equipment. For example, the feed motor 208 can catch a sheet of paper inserted into the feed tray 112 of the shredding device 100 and advance it to the paper blades for shredding. The feed motor 208 can also be coupled to a relay control circuit, similar to the main motor 206, to protect against overheating and overload. In yet other embodiments, the main motor 206 can take the place of the feed motor 208.

As further illustrated in FIG. 2, the safety system 200 can comprise one or more sensors or detectors. In certain embodiments, the sensors can be used to promote the safe and effective operation of a piece of office equipment. The feed sensor 210 can be used to detect when a paper or other type of non-paper media is being inserted into the piece of office equipment. Upon detecting entry, the feed sensor 210 can transmit a signal to the processor 202 to start operation of the main motor 206 and/or the feed motor 208. The feed sensor 210 can transmit a signal to the processor 202 to cease operation when the paper or other non-paper media is no longer detected. In certain embodiments, the feed sensor 210 is an infrared sensor. In yet other embodiments, the feed sensor 210 can comprise a pressure or touch sensor, a photographic sensor, an optical sensor, a mechanical switch, or the like.

In certain embodiments, the safety system 200 comprises multiple feed sensors 210. For example, with reference to the shredding device 100, the safety system 200 can include a media feed sensor, an auto feed sensor and a manual feed sensor. The media feed sensor can be placed near the throat of the manual feed slot 110 and can be configured to automatically activate operation of media blades upon detecting the presence of a disk, CD, or other non-paper media within the media feed slot 110. The auto feed sensor can be placed near the throat of the feed tray 112 and can be configured to automatically activate the feed motor 208 upon detection of sheets of paper being inserted into the feed tray 112. The manual feed sensor can be placed near the throat of the paper feed slot 108 and can be configured to automatically activate operation of paper blades upon detecting the presence of a sheet of paper being inserted into the paper feed slot 108.

The proximity sensor 212 can detect the presence of a human animal or object within a restricted safety zone during the automatic operation of a piece of office equipment. In certain embodiments, the proximity sensor 212 detects human motion within a prescribed area in proximity with a potentially dangerous access region of the piece of office equipment. The access region can be any portion of the office equipment that provides user access to the moving components of the office equipment, which can be located externally or internally. In certain embodiments, the proximity sensor 212 can be used to prevent human touch to moving parts of a piece of office equipment that could lead to injury if touched. In certain embodiments, the proximity sensor 212 can detect motion, temperature, proximity, and/or the like.

The safety system 200 can advantageously comprise multiple proximity sensors 212 to aid in detection and prevention of injury. For example, the illustrated shredding device 100 comprises two proximity sensors 118A, 118B positioned on opposite sides of the lower end of the paper tray 112.

In certain embodiments, the proximity sensor 212 comprises a passive infrared (PIR)-based motion sensor configured to detect movement of animate objects within a designated detection zone of the PIR-based motion sensor. For instance, the PIR-based motion sensor can include one or more pyroelectric infrared elements in certain embodiments. In certain embodiments, the PIR-based motion sensor comprises a Model No. PIS01E PIR Pyroelectric Infrared Sensor (Human Body Sensor) available from Waitrony Co. (Guangdong, China).

In certain embodiments, an infrared-sensitive element is configured to detect changing patterns of passive infrared emitted by animate objects within a detection zone of the PIR-based motion sensor. The PIR-based motion sensor, for example, can detect when an infrared emitting source having one temperature, such as a finger generally at a normal human body temperature, enters a detection zone having another temperature. The PIR-based motion sensor can include two infrared-sensitive elements configured to suppress interference due to temperature variation, thereby ensuring that the PIR-based motion sensor is highly sensitive to human body movement while remaining insensitive to ambient temperature change, vibration or optical noise.

For example, when a human body part enters the detection zone and is in motion, a voltage potential difference is created between the two sensing elements for a short period of time until the two sensing elements return to an equilibrium state, thereby creating a detection event. Ambient temperature change, vibration, or optical noise, however, is usually located at a fixed position or changing very slowly, and therefore, the voltage potential difference between the two sensing elements is zero or approximately zero.

In certain embodiments, the PIR-based motion sensor detects movement of objects having a temperature of between approximately 20 degrees Celsius and approximately 45 degrees Celsius. In certain embodiments, the PIR-based motion detector disregards movement of objects having a temperature below approximately 20 degrees Celsius and/or above approximately 45 degrees Celsius. In other embodiments, the PIR-based motion detector detects movement of objects having a temperature between −30 degrees Celsius and approximately 70 degrees Celsius. In certain embodiments, the PIR-based motion sensor is configured to sense infrared energy having a wavelength between approximately seven and approximately twelve microns, thereby limiting the sensitivity to infrared energy emitted by human bodies, which typically radiate infrared energy having a wavelength between nine and ten microns. In other embodiments, the PIR-based motion sensor disregards infrared energy outside the range of approximately seven and approximately twelve microns.

In certain embodiments, the PIR-based motion sensor detects movement that is fast enough to create a voltage potential difference between the two sensing elements of the PIR-based motion sensor. In certain embodiments, the PIR-based motion detector generates a detection event within 0.15 second of entry by an object into the detection zone. In certain embodiments, the PIR-based motion sensor disregards motion if it is sufficiently slow such that a non-negligible voltage potential difference is not generated between the two sensor elements of the PIR-based motion sensor.

In other embodiments, the proximity sensor 212 utilizes eddy current, inductive, photoelectric, ultrasonic, and/or Hall effect technologies. In certain embodiments, the proximity sensor 212 can transmit a signal to the processor 202, which in turn can generate a signal to temporarily stop the main motor 206 and/or the feed motor 208 until safe operation can be assured. In certain embodiments, the main motor 206 and/or the feed motor 208 are stopped immediately (e.g., within one second) upon entry of an object within the detection zone.

The safety system 200 can also include a timer 214 in communication with the proximity sensor 212 and the processor 202. In certain embodiments, the timer 214 is integrated with the processor 202 or the proximity sensor 212. Generally, the timer 214 can be used by the safety system 200 in determining when it is safe to resume automatic operation of the office equipment. The timer 214 can be used, for example, to determine the amount of time that has elapsed since the most recent detection event of the proximity sensor 212. In certain embodiments, the timer 214 can be reset each time a detection event is generated by the proximity sensor 212. In certain embodiments, the timer 214 is reset immediately (e.g., within one second) after detection of human motion. In certain embodiments, the main motor 204 and/or feed motor 208 will resume operation when the timer 214 reaches a predetermined time value after being reset (e.g., five to ten seconds).

In yet other embodiments, the safety system 200 does not allow the office equipment to resume general operation until a resume event occurs. Such a resume event can include appropriate input received from a user, such as through the user interface 218. In yet other embodiments, a resume event can include a disconnection of power to the main motor 204.

In certain embodiments, the capacity sensor 216 can detect if a piece of office equipment has reached, or is approaching, its storage capacity. For example, the capacity sensor 216 of the shredding device 100 can detect when the waste portion 104 is full of shredded paper or other media and needs to be emptied. In other embodiments, the capacity sensor 216 can detect the absence of materials required to generate a desired output. For example, the capacity sensor 216 can indicate that a laminator is out of laminating material.

In certain embodiments, the safety system 200 can advantageously include multiple capacity sensors 216. The multiple capacity sensors can result in higher precision and credibility. For example, the safety system 200 can be configured such that a control signal is sent to the processor 202 to cease operation only when two or more capacity sensors 216 detect a full capacity at approximately the same time. In certain embodiments, the capacity sensor 216 comprises one or more photographic infrared sensors.

With continued reference to FIG. 2, the user interface 218 comprises a display portion and/or a user input portion in communication with the processor 202. The display portion and/or the user input portion can be physically integrated into the housing of the office equipment. For example, as illustrated in FIGS. 1A and 1B, the display portion 114 and the input control portion 116 are physically integrated within the housing 106 of the shredding device 100. In other embodiments, the display portion and/or the user input portion are separate physical components in communication with the office equipment.

In certain embodiments, the display portion comprises a monitor or screen capable of displaying visual text or graphics. In other embodiments, as shown in FIGS. 1A and 1B, the display portion comprises one or more LEDs with accompanying text labels. The LEDs, for example, can be capable of emitting light of one or more colors to indicate operational status.

With specific reference to the shredding device 100, the display portion can indicate, for example, that the shredding device 100 is powered on, that the waste portion 104 is full, that an access door 120 of the waste portion 104 is open, that a motor is currently overloaded and/or in danger of overheating, that a detection event has been generated by one of the proximity sensors 118, and/or the like. In certain embodiments, the display portion can include one or more speakers to output audible alerts or notifications to a user.

In yet other embodiments, the user interface 218 can be configured to emit a warning signal (e.g., audible and/or visible) when a detection event has occurred. For instance, an audible signal can be used to deter children and/or animals (e.g., via a high-pitch signal) from approaching and/or remaining near the office equipment.

The input portion can include one or more input devices, such as a keyboard, a mouse, a touch screen display, one or more buttons, one or more toggle switches, one or more sliding switches, and the like. In certain embodiments, the input portion can be used to toggle power on and off and control the operation of the office equipment. For example, the shredding device 100 can include a button to cause the paper blades and/or media blades to operate in forward motion and a button to cause the paper blades and/or media blades to operate in reverse motion. Reverse motion can be triggered, for example, in the event of a paper jam or if the shredding device 100 has reached full capacity. The input portion may also be used to resume automatic operation of the office equipment after a detection event has occurred.

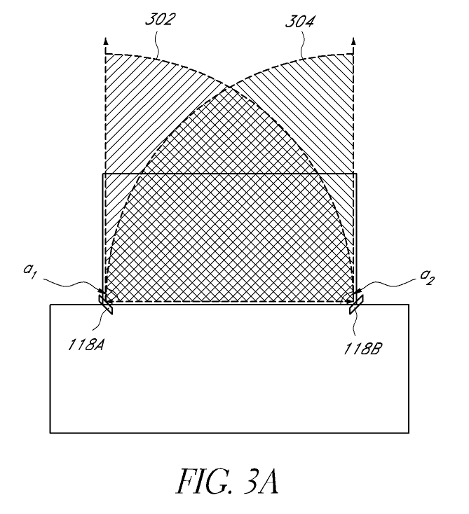

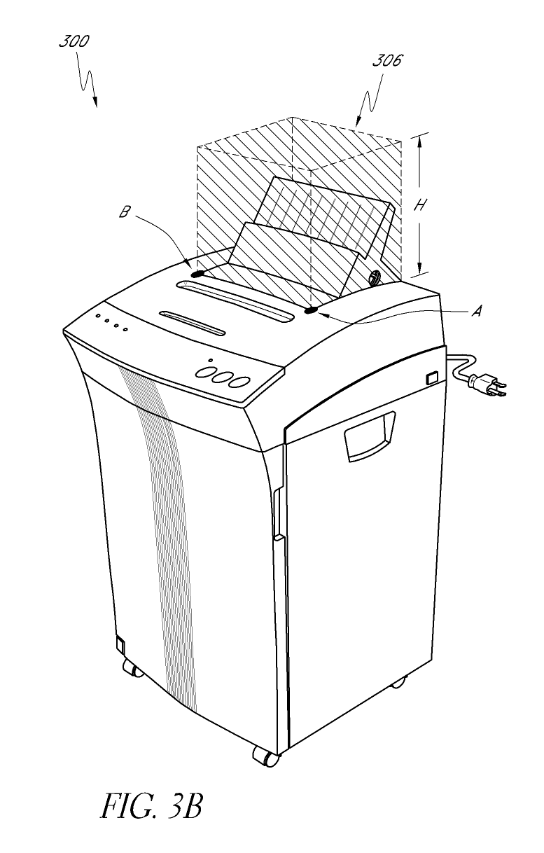

FIG. 3A illustrates an exemplary embodiment of detection zones 302, 304 associated with two proximity sensors placed on opposite sides of an access region of a piece of office equipment. In certain embodiments, the detection zone(s) represent a two-dimensional and/or three-dimensional space in which human movement (or other interested movement) therein triggers a detection event. For exemplary purposes, the detection zones 302, 304 will be described herein with reference to the proximity sensors 118A, 118 of the shredding device 100 of FIG. 1A.

In certain embodiments, the range, or scope, of the detection zones 302, 304 can be adjusted by the manufacturer and/or by the end user via a user interface. As shown, the detection zones 302, 304 extend out from the proximity sensors 118 at a defined angle. In particular, the detection zone 302 of proximity sensor 118A extends out at an angle a₁, and the detection zone 304 of proximity sensor 118B extends out at an angle a₂. In certain embodiments, angle a₁ and angle a₂ can be substantially equivalent. In certain embodiments, angle a₁ and angle a₂ are greater than or equal to approximately ninety degrees; however, it should be appreciated that the angles can be adjusted to any suitable degree. In certain embodiments, angles a₁ and a₂ are between 90 and 140 degrees.

In addition, the reach (e.g., radius) of the detection zones can be set to particular dimensions based on a variety of factors, such as the type of office equipment, the location of the sensors, the desired sensitivity level, and/or the like. The proximity sensors 118A, 118B can be positioned at an angle facing inward from their respective corners. The detection zones 302, 304 can be configured to at least partially overlap in order to increase the probability of detection and to enlarge the total range, or field of view, of the detection zones 302, 304. In certain embodiments, the detection zones 302, 304 substantially or completely overlap. Moreover, it should be appreciated that although the detection zones 302, 304 have been illustrated two-dimensionally in FIG. 3A, they can also extend in three dimensions. For example, the field of view of each detection zone can be 120 degrees along a first axis and 110 degrees along a second axis perpendicular to the first axis.

In certain embodiments, the proximity sensor 118A is configured to generate a signal usable to stop the operation of the shredding device 100 when a human body part enters the detection zone 302, and the proximity sensor 118B is configured to generate a signal usable to stop the operation of the shredding device 100 when a human body part enters the detection zone 304. The stop signals can be generated immediately (e.g., within one second) after human motion detection within the detection zones 302, 304. In certain embodiments, the stop signals are transmitted to the processor 202, which in turn can generate signals to stop the main motor 206 and/or the feed motor 208. In certain embodiments, the presence of the human body part only needs to be detected by one of the proximity sensors 118 in order to stop the operation of the shredding device 100.

FIG. 3B illustrates an exemplary embodiment of a detection zone 306. In certain embodiments, a first proximity sensor can be placed at point A, and a second proximity sensor B can be placed at point B on opposite sides of a potentially dangerous access region of a piece of office equipment (e.g., a throat of shredding device). Although the detection zone 306 is illustrated using a shredding device 308, it can be used with any piece of office equipment having potentially dangerous access regions. In certain embodiments, one of the proximity sensors placed at points A and B is sufficient to at least substantially cover the detection zone 306.

In certain embodiments, the proximity sensor placed at point B is included for redundancy in case the proximity sensor placed at point A fails or otherwise malfunctions. In yet other embodiments of the invention, multiple proximity sensors must sense motion within the detection zone 306 in order to generate a stop signal or cease operation of the motor. Such embodiments advantageously provide redundancy to prevent premature or unnecessary triggering of a stop signal.

In certain embodiments, the vertical height H of the detection zone 306 is about thirty-six inches. In other embodiments, the vertical height H is between about twelve inches and about forty-eight inches. In some embodiments, the vertical height H can be adjusted pre- or post-manufacture.

In certain embodiments, detection zone 306 extends from points A and B to a back portion of the shredding device 300 and from point A to point B (as illustrated by the three-dimensional detection zone 306 of FIG. 3B). In certain embodiments, the shape and dimensions of the detection zone 306 are controlled and/or configured by lenses, prisms, mirrors, and/or the like. For example, the shape and dimension of the detection zone 306 can be controlled by the use of multiple Fresnel lenses, by a segmented parabolic mirror, by the sensor housing and/or by the orientation of the sensor. In certain embodiments, the field of view of the detection zone can be adjusted post-manufacture by removing segments of a masking lens or mirror.

Although certain embodiments of the invention have been illustrated herein as having a pair of sensors for identifying nearby movement, other embodiments of the invention can utilize any number of proximity sensors and/or detection zones.

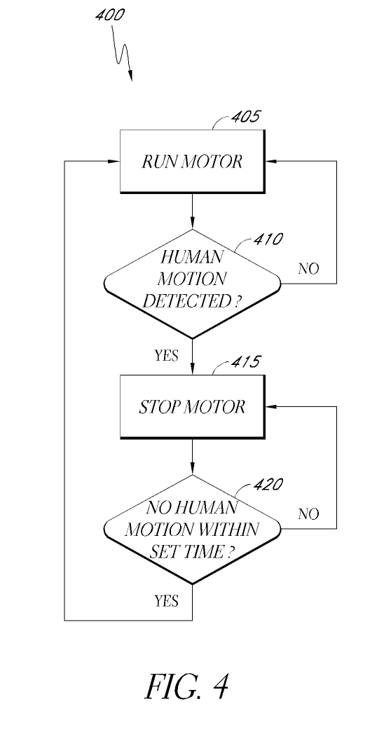

FIG. 4 illustrates a flowchart of an exemplary embodiment of a safety process 400 for controlling operation of a piece of electronic office equipment. In certain embodiments, the safety process 400 is executed by the safety system 200 of FIG. 2 to prevent injury to a child, adult, or pet in close proximity to the moveable components of a piece of office equipment. For exemplary purposes, the safety process 400 will be described herein with reference to the components of the safety system 200 of FIG. 2.

As shown in FIG. 4, the safety process 400 begins with Block 405, where the main motor 206 of the office equipment is running automatically. At decision block 410, the safety system 200 determines whether human motion has been detected within a restricted safety zone, such as the detection zone 306 of FIG. 3B. In certain embodiments, human motion can be detected by one or more proximity sensors, such as PIR-based motion detectors. If human motion has been detected, then the safety process 400 proceeds to Block 415, wherein the processor 202 of the safety system 200 stops the operation of the main motor 206 and/or the feed motor 208. Otherwise, the safety process 400 returns to Block 405 and the office equipment continues in its normal operation.

In certain embodiments, the operation of the office equipment is only disabled temporarily while human or animal motion is detected within the prescribed detection zones 302,304 of the proximity sensors 118. Proceeding to decision block 420, the safety system 200 determines whether enough time has elapsed since the last detection event of the proximity sensor 212 to safely resume automatic operation of the office equipment. In certain embodiments, the safety system 200 can wait until a predetermined time has elapsed without a detection event.

In some embodiments, the predetermined time can be between five and ten seconds. In other embodiments, the safety system 200 can wait until fewer than five seconds or greater than ten seconds has elapsed. The predetermined time can be adjusted in certain embodiments. In some embodiments, the processor 202 can poll the timer 214 to determine the elapsed time since the last detection event. If no detection control signals have been received by the processor 202 within the predetermined time, then the safety process 400 returns to Block 405 and operation of the main motor 206 is resumed. Otherwise, the safety process 400 returns to Block 415.

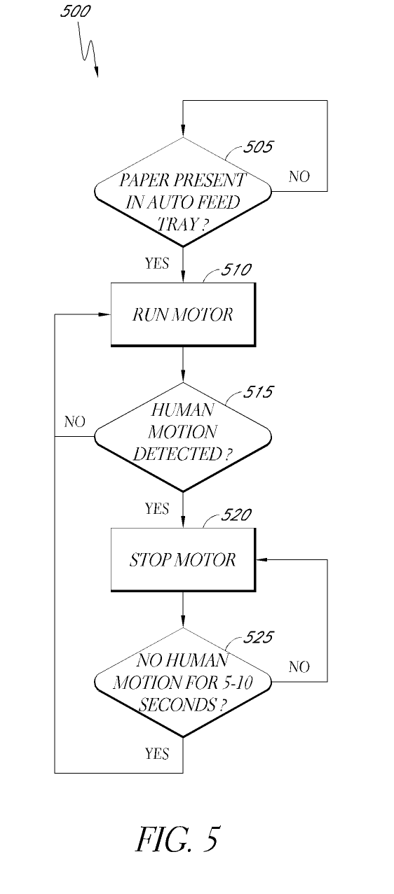

FIG. 5 illustrates a flowchart of an exemplary embodiment of another safety process 500 for controlling operation of a piece of office equipment. In certain embodiments, the safety process 500 is executed by the safety system 200 of FIG. 2 to prevent injury to a child, adult, or pet in close proximity to the moveable components of a piece of office equipment. For exemplary purposes, the safety process 500 will be described herein with reference to the components of the safety system 200 of FIG. 2 and the shredding device 100 of FIG. 1A.

As shown in FIG. 5, the safety process 500 starts at decision Block 505, in which the safety system 200 determines whether or not paper is present in the auto feed tray 112 (e.g., via feed sensor 210). If paper is present in the auto feed tray 112, then the safety process 500 proceeds to Block 510. At Block 510, the processor 202 issues a command to start the main motor 206 and/or the feed motor 208. If there is not any paper present in the auto feed tray 112, then the safety process 500 remains at decision Block 505.

At decision Block 515, the safety system 200 determines whether human motion has been detected within a restricted safety zone, such as the detection zones 302, 304 of FIG. 3. In certain embodiments, human motion can be detected by one or more proximity sensors, such as PIR-based motion detectors. If human motion has been detected, then the safety process 500 proceeds to Block 520, wherein the processor 202 of the safety system 200 stops the operation of the main motor 206 and/or the feed motor 208. Otherwise, the safety process 500 returns to Block 510 and the shredding device 100 continues in its normal operation.

Proceeding to decision Block 525, the safety system 200 determines whether enough time has elapsed since the last detection event of the proximity sensor 212 to safely resume operation of the office equipment. In certain embodiments, the safety system 200 can wait until a predetermined time has elapsed without a subsequent detection event. In some embodiments, the predetermined time can be between about five and ten seconds. In other embodiments, the safety system 200 can wait until fewer than five seconds or greater than ten seconds has elapsed. The predetermined time can be adjusted in certain embodiments.

In some embodiments, the processor 202 can poll the timer 214 to determine the elapsed time since the last detection event. If no detection control signals have been received by the processor 202 within the predetermined time, then the safety process 500 returns to Block 510 and operation of the main motor 206 and/or the feed motor 208 is resumed. Otherwise, the safety process 500 returns to Block 520.

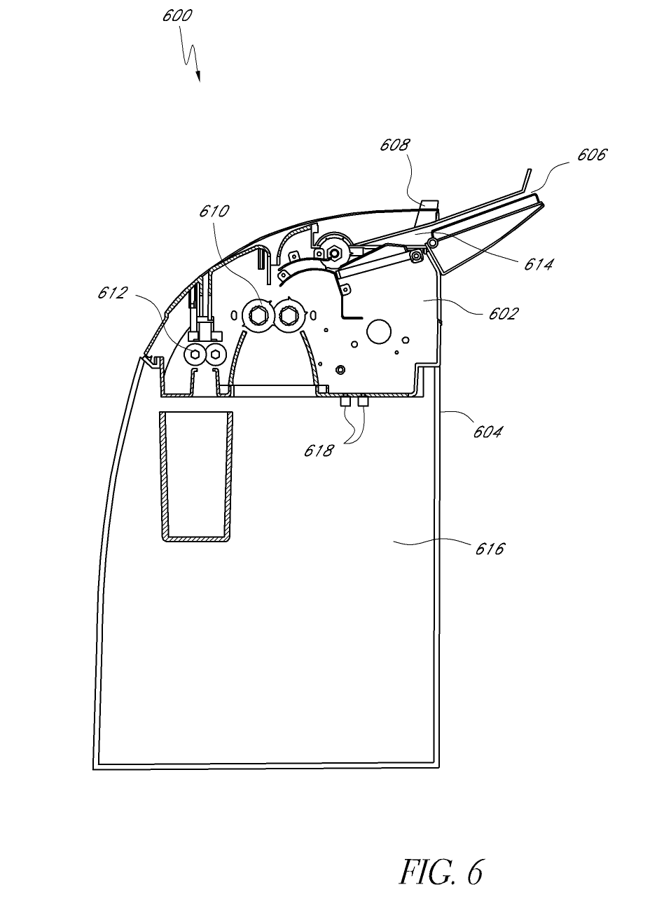

FIG. 6 illustrates a cross-sectional view of a shredding device 600 incorporating certain embodiments of the invention. In particular, the shredding device 600 comprises a shredder portion 602 and a waste portion 604. The shredder portion 602 comprises a feed tray 606, PIR-based motion detectors 608, paper blades 610, and media blades 612. As shown, the PIR-based motion detectors 608 are positioned near a throat 614 of the shredding device 600. In certain embodiments, the PIR-based motion detectors 608 operate as described above in connection with FIG. 3.

The waste portion 604 comprises a paper receptacle 616 and at least one capacity sensor 618 for detecting when the paper receptacle 616 reaches a full state. In certain embodiments, multiple capacity sensors 618 are used in order to verify that a single capacity sensor 618 does not prematurely output a basket full signal. The multiple capacity sensors 618 can advantageously be positioned at various locations of the waste portion 604. The capacity sensors are not necessarily illustrated to scale. In certain embodiments, the basket full signal can only be generated if more than one capacity sensor 618 detects that the paper receptacle 616 is full at approximately the same time. In certain embodiments, the basket full signal can cause the paper blades 610 to stop operation until the paper receptacle 616 is emptied. In certain embodiments, the shredding device 600 further incorporates the safety system 200 of FIG. 2.

Embodiments of the invention can be implemented in a wide variety of consumer-sized shedding devices, such as those disclosed in one or more of the following patent and applications: U.S. Pat. No. 6,390,397, issued May 21, 2002; U.S. patent application Ser. No. 11/227,994, filed Sep. 15, 2005, published as U.S. Patent Application Publication No. 2006-0054727 on Mar. 16, 2006; and U.S. patent application Ser. No. 11/594,708, filed Nov. 8, 2006, published as U.S. Patent Application Publication No. 2007-0181721 on Aug. 9, 2007, each of which is hereby incorporated herein by reference in its entirety and is to be considered part of this specification. In addition, embodiments of the invention can be implemented in a wide variety of other electronic office equipment, such as laminators, printers, copiers, letter folding machines, and the like. Moreover, one or more features disclosed herein with reference to one figure or embodiment can be used interchangeably with other disclosed embodiments of the invention.

While certain embodiments of the invention have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A safety-controlled automatic-feed shredding device, the device comprising:
at least one cutting element configured to shred media coming in contact therewith during operation of the at least one cutting element;
a feed tray comprising a feed mechanism configured to automatically advance the media to the at least one cutting element;
at least one motor configured to drive the at least one cutting element and the feed mechanism;
a housing substantially enclosing the at least one cutting element and the at least one motor, the housing comprising at least one access slot through which the media passes to come in contact with the at least one cutting element;
a plurality of passive infrared (PIR) -based motion sensors disposed on the housing, each of the plurality of PIR-based motion sensors comprising a pyroelectric sensor element, wherein at least one of the plurality of PIR-based motion sensors is configured to generate a first signal when sensing motion of an individual within a detection zone at least above the housing, the detection zone encompassing a region including or substantially proximate the at least one access slot; and
a controller in communication with the plurality of PIR-based motion sensors and the at least one motor, the controller being configured to cause the at least one motor to cease driving the at least one cutting element in response to receiving the first signal.

2. The device of claim 1, further comprising a timer in communication with at least one of the controller and the plurality of PIR-based motion sensors, wherein the controller is configured to suspend operation of the at least one motor for a predetermined time as measured by the timer.

3. The device of claim 2, wherein the predetermined time is at least five seconds.

4. The device of claim 3, wherein the timer is configured to reset upon receipt of the first signal.

5. The device of claim 1, wherein the feed tray comprises a paper feed tray.

6. The device of claim 1, wherein the controller is further configured to cause the at least one motor to cease driving the feed mechanism in response to receiving the first signal.

7. The device of claim 1, further comprising a user interface, wherein the controller is further configured to instruct the user interface to issue an alarm in response to receiving the first signal.

8. The device of claim 7, wherein the alarm comprises an audible alarm.

9. A safety system for controlling operation of electronic office equipment, the safety system comprising:
an automatic office apparatus comprising,
a controller,
at least one moveable component,
a motor configured to operate the at least one moveable component, and
an access region adjacent the at least one moveable component; and
a plurality of passive infrared (PIR) -based motion detectors positioned on substantially opposite ends of the access region, the plurality of PIR-based motion detectors configured to detect movement within respective detection zones in proximity with the access region, the respective detection zones being defined by configurable detection angles of the PIR-based motion detectors,
wherein upon detection of motion within a respective detection zone by at least one of the plurality of PIR-based motion detectors, the at least one PIR-based motion detector is configured to transmit a motor stop signal to the controller of the automatic office apparatus to disable operation of the motor.

10. The safety system of claim 9, wherein the automatic office apparatus comprises a shredder.

11. The safety system of claim 9, wherein the automatic office apparatus comprises a laminator.

12. The safety system of claim 9, wherein the detection zone encompasses a region at least approximately twenty-four (24) inches above the access region.

13. The safety system of claim 9, wherein the controller is configured to continue disabling operation of the motor until an occurrence of a resume event.

14. The safety system of claim 13, wherein the resume event comprises at least one of input from the user and disconnection of power to the motor.

15. The safety system of claim 9, wherein the respective detection zone of each of the plurality of PIR-based motion detectors comprises a three-dimensional detection zone.

16. The safety system of claim 9, wherein the plurality of PIR-based motion detectors is configured to disregard movement of objects having a temperature outside the range of approximately twenty (20) degrees Celsius to approximately forty-five (45) degrees Celsius.

17. A method for controlling operation of electronic office equipment, the method comprising:
enabling operation of an electric motor of an electronic office appliance, the electric motor being configured to drive at least one moveable component associated with the electronic office appliance;
detecting human motion within a prescribed safety zone in proximity with the at least one moveable component of the electronic office appliance by at least two passive infrared (PIR)-based motion detectors disposed on the electronic office appliance;
automatically disabling operation of the electric motor upon detecting human motion within the prescribed safety zone during operation of the electric motor; and
resuming operation of the electric motor after a predetermined time interval has elapsed without the detection of subsequent human motion within the prescribed safety zone.

18. The method of claim 17, additionally comprising issuing an alarm upon detecting human motion within the prescribed safety zone during operation of the electric motor.

19. The method of claim 17, wherein said detecting human motion further comprises disregarding motion of objects having a temperature outside the range of approximately twenty (20) degrees Celsius to approximately forty-five (45) degrees Celsius.

20. The method of claim 19, wherein said detecting human motion further comprises disregarding infrared energy having a wavelength outside the range of approximately seven (7) microns to approximately twelve (12) microns.
